(19) United States
(12) Patent Application Publication
(10) Pub. No.: US 2012/0311715 A1
(43) Pub. Date: Dec. 6, 2012

(54) SYSTEM AND METHOD FOR PROTECTING A WEBSITE FROM HACKING ATTACKS

(76) Inventors: YARON TAL, Holon (IL); Nitzan Miron, Zur Yigal (IL)

(21) Appl. No.: 13/481,964

(22) Filed: May 29, 2012

Related U.S. Application Data
(60) Provisional application No. 61/491,297, filed on May 30, 2011.

(51) Int. Cl. G06F 21/00

(52) U.S. Cl. 726/25

(57) ABSTRACT

A system and method for protecting at least one server, in communication with a computer network, from hacking attacks including a scanner, a report processor and a control center. The scanner may monitor activity of the server, identify at least one security vulnerability, produce an automated report. The report processor may analyze the automated report and generate fixes for identified vulnerabilities.

### CROSS-REFERENCE TO RELATED APPLICATIONS

This application claims priority benefit from U.S. Provisional Patent Application No. 61/491,297, filed May 30, 2011, which is incorporated herein by reference in its entirety.

### FIELD OF THE INVENTION

The disclosure herein relates to internet security. In particular the disclosure relates to web based systems for protecting servers from hacking attacks.

### BACKGROUND OF THE INVENTION

Millions of Websites are hacked every year, and this trend is on the rise. Both small and large sites are being affected. In one recent event, Sony was hacked, taking the entire Playstation network offline for weeks and revealing customers' credit card information to hackers. They are not the only ones.

Despite this worrying picture, most website owners today have no easy way to protect their websites, as reasonable protection can only be achieved by using tools that require in-depth technical knowledge, or hiring security specialists, which is prohibitively expensive for all but very large websites, and often to slow and inadequate.

There is therefore a need for an effective system for protecting websites and other computing systems connected to the internet. The present disclosure addresses this need.

### SUMMARY OF THE INVENTION

A variety of website intrusion protection systems may be used to check for external penetration into sites. Where such penetrations are discovered, patches or other protective elements may be written and installed to protect against such attacks. In many cases, such protective elements are used in conjunction with Intrusion Prevention Systems (IPS), also known as Intrusion Detection and Prevention Systems (IDPS). Intrusion Prevention Systems are network security appliances that may monitor network and/or system activities for malicious activity. The main functions of intrusion prevention systems are to identify malicious activity, log information about the activity, attempt to block/stop the activity, and report the activity.

Intrusion prevention systems are considered extensions of intrusion detection systems because they both monitor network traffic and/or system activities for malicious activity. The main differences are, unlike intrusion detection systems, intrusion prevention systems may be placed in-line and are able to actively prevent/block intrusions that are detected. More specifically, an IPS may take such actions as sending an alarm, dropping the malicious packets, resetting the connection and/or blocking the traffic from the offending IP address. Where required an IPS may also correct Cyclic Redundancy Check (CRC) errors, defragment packet streams, prevent TCP sequencing issues, clean up unwanted transport and network layer options and the like.

Some systems may be able to provide a certain amount of protection at least for the low layers of a web server, including the physical layer, network layer, and transport layers. Nevertheless, the higher layer, or the application layer, may be considerably more vulnerable to attack. It is a particular feature of the present disclosure that a protection system is introduced which may provide protection for the application layer thereby increasing the overall security of a server.

Accordingly, it is one aspect of the current disclosure to present a system for protecting at least one server, in communication with a computer network, from hacking attacks. The system may comprise at least one scanner and at least one report processor. The scanner may be operable to monitor activity of the server, to identify at least one security vulnerability, and further operable to produce an automated report.

The report processor may be operable to analyze the automated report. Optionally, the report processor may be further operable to generate at least one protective element so as to prevent exploitation of the at least one vulnerability. Variously, the system may generate a protective element comprising a software based element selected from a group consisting of: patches, virtual patches, black lists, filters, reconfigurations, redirects and combinations thereof or the like.

Where appropriate, the system may further comprise at least one communicator operable to communicate at least one protective element to the server so as to prevent exploitation of at least one vulnerability.

In some embodiments, the system may furthermore comprise a control center operable to manage at least one of the scanner and the report processor. Where the system includes a communicator, the control center may be operable to manage at least one of the scanner, the report processor and the communicator.

Accordingly, the control center may be operable to instruct the scanner to initiate monitoring activity. Alternatively or additionally, the control center may be operable to configure a timed schedule for monitoring activity.

In some embodiments of the system, the control center is operable to receive the automated report from the scanner and to transfer the automated report to the report processor. In other embodiments, the scanner may be operable to transfer the automated report directly to the report processor. In some embodiments the control center is operable to receive at least one protective element from the report processor. Optionally, the control center is operable to communicate at least one protective element to the server. In other embodiments, the report processor may be operable to send protective elements directly to the server. Where appropriate, the control center may be controllable manually. Optionally the control center may be controllable by a user, a web manager or the like.

Optionally, according to some embodiments of the system, an agent application is executed on the at least one server and the system is operable to communicate with the agent application. Variously, the agent application may be operable to save a log of activity occurring on the server. For example, the agent application may be configured an operable to log traffic to and from the server. Such logs may, for example, record various elements such as, inter alia, data pertaining to identities and activities of remote hosts accessing the system, resources accessed by each remote host, actions performed, data associated with actions performed, performance data or the like.

Accordingly, the agent application may be operable to implement the protective elements on the server. Additionally, or alternatively, the agent application may be operable to block potential threats from exploiting at least one security vulnerability. Furthermore, the agent application may be operable to provide the scanner access to the server.

According to another aspect of the disclosure a system is presented for protecting a plurality of servers in communication with a computer network from hacking attacks. The system for protecting a plurality of servers may comprise: at least one aggregator and at least one data processor. The aggregator may be configured to receive data relating to activity of the plurality of servers. The data processor operable to analyze the data relating to activity of the plurality of servers and to identify at least one security vulnerability common to at least a selection of the plurality of servers. Optionally, the data processor is further operable to generate at least one protective element so as to prevent exploitation of at least one common vulnerability. Additionally the system for protecting a plurality of servers may further comprise at least one communicator operable to communicate at least one protective element to at least one of the selection of vulnerable servers.

According to still another aspect of the disclosure, a method is taught for protecting at least one server in communication with a computer network from hacking attacks. The method may comprise: executing an agent application on at least one server; monitoring activity of at least one server; identifying at least one security vulnerability; producing an automated report; analyzing the automated report; and providing at least one software based protective element.

Where appropriate, the method may be extended to protect a plurality of servers, for example by aggregating data relating to activity of a plurality of servers; analyzing the data relating to activity of the plurality of servers; identifying at least one security vulnerability common to at least a selection of the plurality of servers; optionally generating at least one protective element for preventing exploitation of at least one common vulnerability; and perhaps communicating at least one protective element to at least one of the selection of vulnerable servers.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1A is a block diagram schematically representing one system for protecting a server from hacking attacks by providing a user with a report of potential vulnerabilities;

FIG. 1B is a block diagram schematically representing another system for protecting a server from hacking attacks by providing an intrusion detection and prevention system;

FIG. 1C is a block diagram schematically representing a further system for protecting a server from hacking attacks by providing a cloud or off-site based intrusion detection and prevention system;

FIG. 2 is a block diagram schematically representing another system for protecting a server from hacking attacks by providing a web based protection module configured identify vulnerabilities on a server and provide protective elements therefor;

FIG. 3 is a block diagram schematically representing still another system for protecting a server from hacking attacks by providing a web based protection module configured identify common vulnerabilities on a plurality of servers and to provide protective elements;

FIG. 4 is a flowchart showing a possible method for protecting a server from hacking attacks using a web based protection module;

FIG. 5 is a flowchart showing a method for protecting a plurality of servers from hacking attacks by using a web based protection module to identify common vulnerabilities shared thereby;

FIG. 6 is a block diagram schematically representing an illustrative embodiment of a web based protection system; and

FIG. 7 is a flowchart showing a possible method operable by the illustrative embodiment of the web based protection system of FIG. 6.

### DETAILED DESCRIPTION OF THE INVENTION

Aspects of the present disclosure relate to internet security. In particular the disclosure relates to web based systems for protecting servers from hacking attacks.

Optionally, a protection system may be provided for protecting a server from hacking attacks. As described herein the protection system may be configured to identify vulnerabilities on the server and provide protective elements therefor.

Other systems may be provided for protecting multiple servers from hacking attacks by identifying vulnerabilities common to more than one of the servers and generating common protective elements such as fixes, patches or the like for execution on the vulnerable servers.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

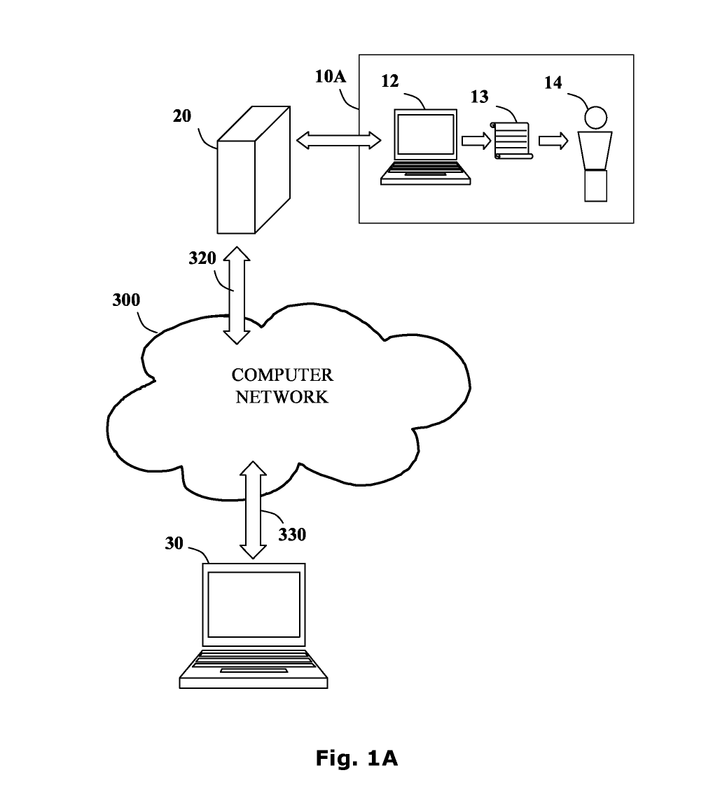

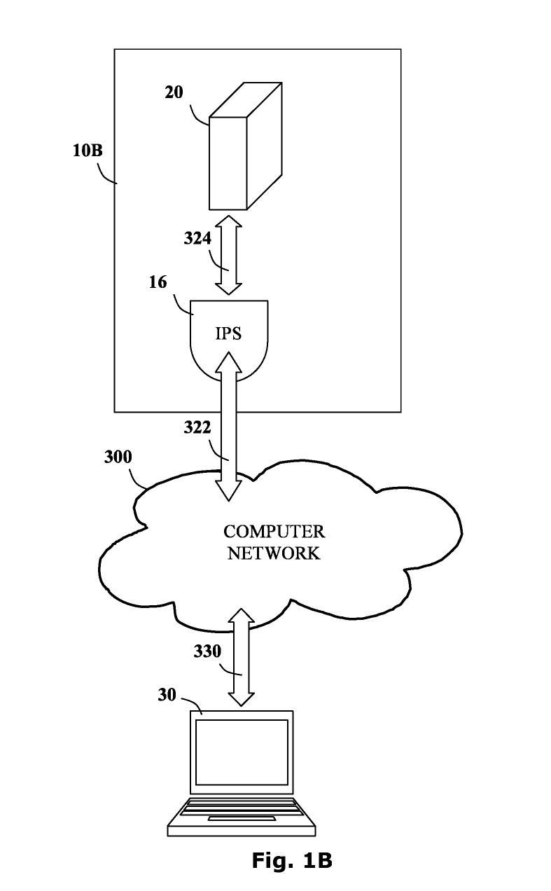

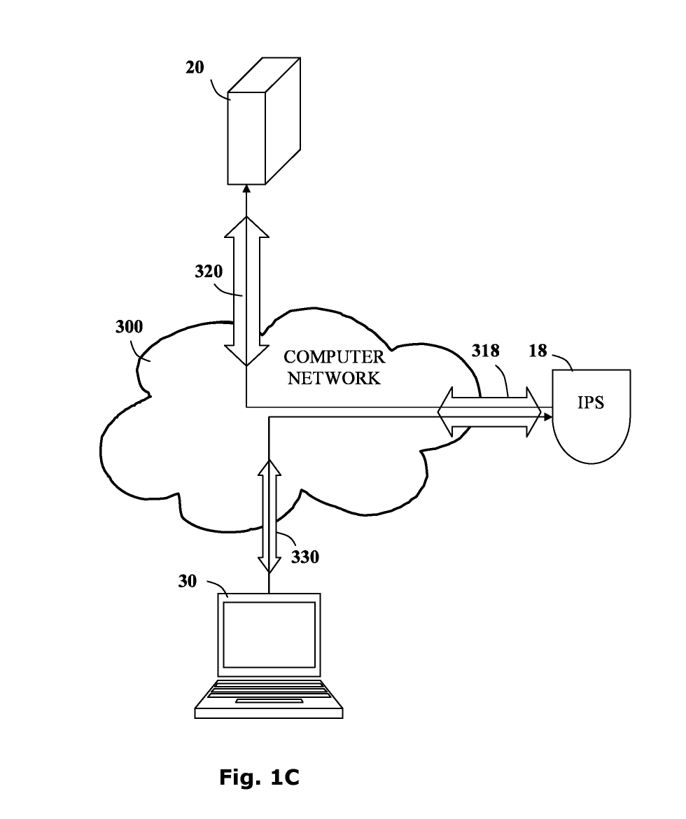

Reference is made to FIG. 1A which schematically represents a system 10A for protecting a server 20 from hacking attacks. The server 20 is connected to a computer network 300 such as the world wide web, internet, intranet, local area network or the like via a network connection 320. A remote computer 30 connected to the computer network 300 via another connection 330 may have access to the server 20 via the computer network 330. Accordingly websites and the like hosted by the server 20 may be accessible remotely.

It will be appreciated that such a server 20 may be at risk of attacks such as hacking attacks from remote computers. Accordingly a protection system 10A may be provided to identify potential vulnerabilities on the server 20 before they are exploited.

The protection system 10A comprises a computer 12, possibly the server itself, operable to scan the server and to generate a user friendly vulnerability report 13 for a manager 14. The vulnerability report 13 may indicate all vulnerabilities identified by the scanner such that the manager 14 may implement patches, fixes or the like as appropriate.

Referring now to FIG. 1B, another system 10B for protecting a server 20 from hacking attacks is schematically represented. An intrusion detection and prevention system 16 is connected to the server 20 via a first connection 324 and the computer network 300 via a second connection 322. The prevention system 16 is introduced between the server 20 and the computer network 300 to filter data transferred therebetween and to effectively shield the server from attack.

With reference to the block diagram of FIG. 1C, schematically representing a web based protection system is shown operable to protect the server 20 from hacking attacks. The web based protection system may include a remote intrusion detection and prevention system 18 connected to the computer network 300 via its own connection 318. The server 20, which is connected to the computer network 300 via its own connection 320 connects to the remote intrusion detection and prevention system 18 via the computer network 300 and receives data therefrom. All traffic to and from the client 30 is directed through the remote intrusion detection and prevention system 18, which is operable to receive all data communication directed to or from the server 20 and to filter out potential attacks remotely.

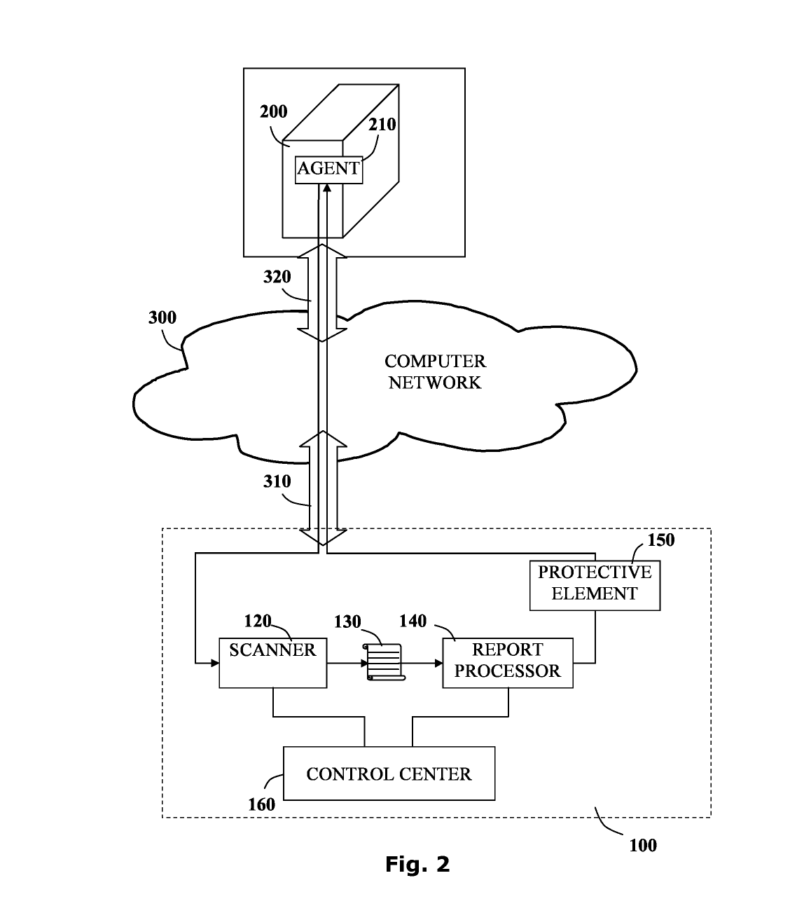

Referring now to FIG. 2, a block diagram is shown schematically representing a particularly noteworthy protection system 100 for protecting a server 200 from hacking attacks. As described herein the protection system 100 may be configured to identify vulnerabilities on the server 200 and provide protective elements therefor.

The protection system 100 may include a scanner 120, a report processor 140, a control center 160 and a server agent 210. The scanner 120 of the protection system 100 may be operable to monitor activity of the server 200, to identify at least one security vulnerability in the server and to produce an automated vulnerability report 130.

The report processor 140 may be operable to receive the automated report 130 from the scanner, to analyze the automated report 130 and to generate at least one protective element 150 directed towards fixing at least one identified vulnerability. Various protective elements 150 may be generated, as appropriate so as to prevent exploitation of the vulnerability. For example, software based protective elements may include patches, virtual patches, black lists, filters, reconfigurations, redirects and the like as well as combinations thereof.

It is particularly noted that unlike the user friendly vulnerability report 13 described above in relation to FIG. 1A, the automated vulnerability report 130 generated by the scanner 120 of the protection system 100 of FIG. 2 is generally a machine readable report configured such that it may be transferred to the report processor for analysis.

The control center 160 may be configured and operable to manage the scanner 120 and/or the report processor 140. Accordingly, the control center 160 may instruct the scanner to initiate monitoring activity, for example by determining a regular timed schedule for monitoring activity, by instructing the scanner to initiate monitoring activity when so prompted by a manager or the like.

Furthermore, the control center 160 may be operable to receive the automated report 130 from the scanner 120 and to transfer the automated report 130 to the report processor 140. Alternatively, the scanner 120 may be configured to pass the automated report 130 directly to the report processor 140.

The protection system 100 may further include a communicator for communicating with the server 200. The communicator may be used to communicate the protective element 150 to the server 200 via communication connections 310 and 320 to the computer network. Accordingly, the control center 160 may manage the communicator, or may itself serve as the communicator.

In particular embodiments of the protection system 100, an agent 210 may be executed on the server and the system 100 is operable to communicate with the agent application 210. Where appropriate, the agent 210 may be operable to perform a variety of functions such as: saving a log of activity on the server 200, implementing the protective elements 150 on the server 200, blocking potential threats from exploiting security vulnerabilities, providing the scanner 120 access to the server and the like.

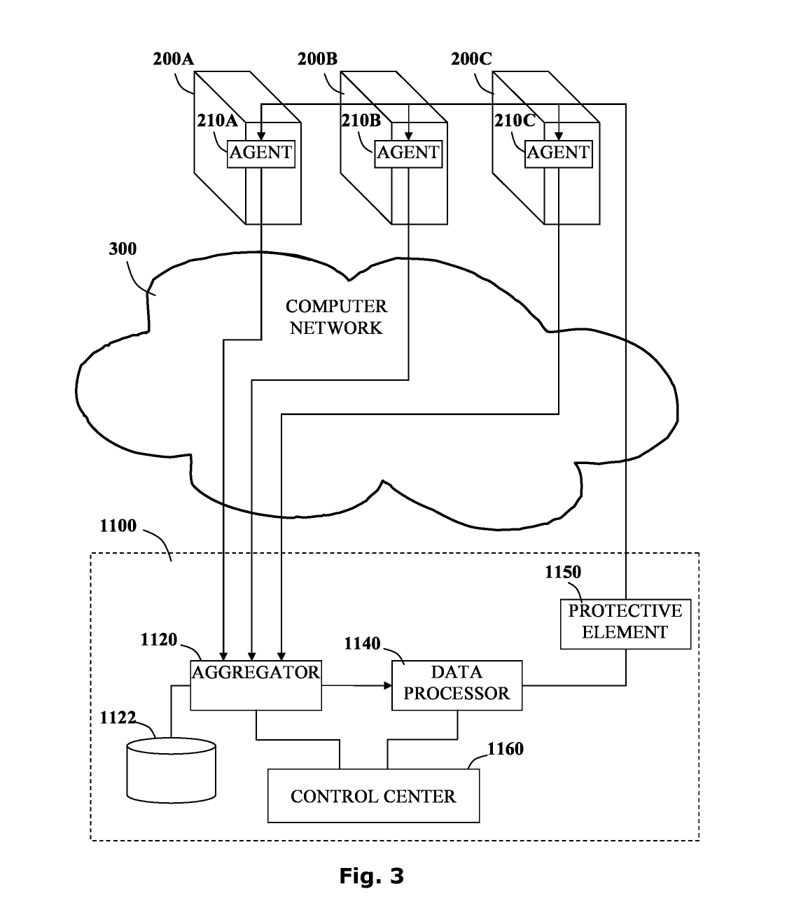

Referring now to FIG. 3 a block diagram is presented schematically representing selected elements of still another system 1100 for protecting a plurality of servers 200A-C from hacking attacks. A web based protection module is configured to identify common vulnerabilities on a plurality of servers and to provide protective elements;

The protection system 1100 may include an aggregator 1120, a data processor 1140 and a control center 1160. The aggregator 1120 may be configured and operable to receive data relating to activity of the plurality of servers 200A-C. Accordingly the aggregator may receive a plurality of vulnerability reports from a plurality of scanners (not shown) such as described herein in relation to FIG. 2. The aggregator 1120 may store historical data in a database 1122 for retrieval as required.

The data processor 1140 may be operable to communicate with the aggregator, possibly via the control center 1160 such that it may analyze the aggregated data relating to activity of the servers 200A-C. The data processor 1140 may thereby identify at least one security vulnerability common to more than one server 200A-C, possibly using statistical analysis of the aggregated data or the like. Accordingly, where appropriate, the data processor 1140 may be further operable to generate at least one protective element 1150 so as to prevent exploitation of the common vulnerability. The protective element 1150 may then be communicated to the servers, perhaps via a communicator.

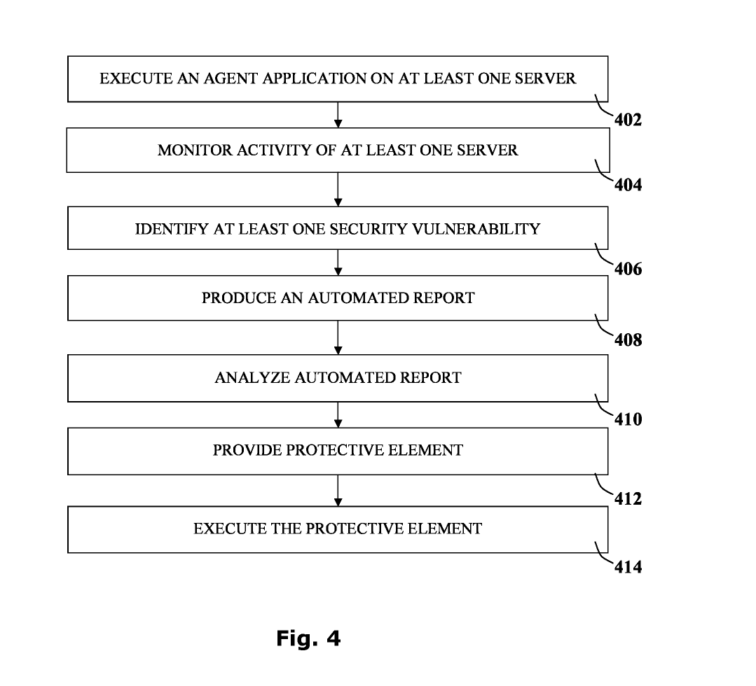

Referring now to the flowchart of FIG. 4 a possible method is presented for protecting a server from hacking attacks using a web based protection module such as described herein. The method includes: executing an agent application on the at least one server 402, monitoring activity of the at least one server 404, identifying at least one security vulnerability 406, producing an automated report 408, analyzing the automated report 410, providing at least one software based protective element 412 and executing the protective element on the server 414.

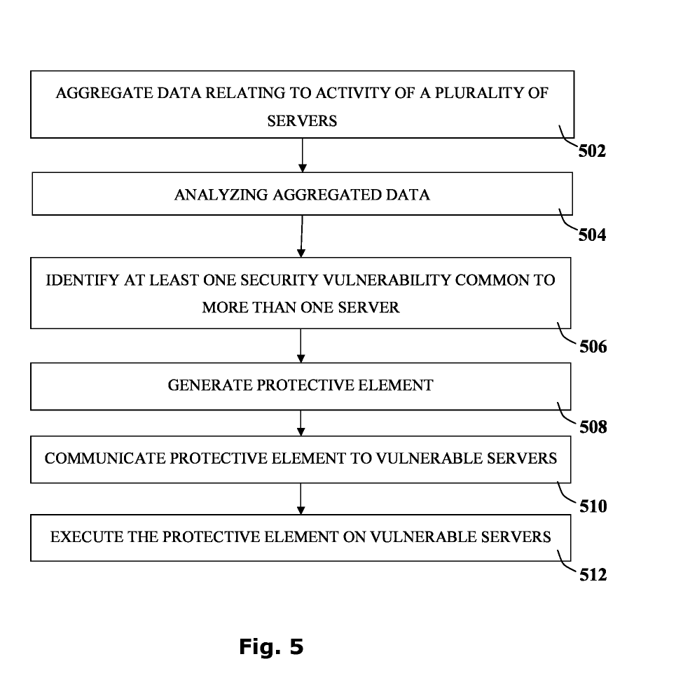

Another method is presented in the flowchart of FIG. 5 demonstrating a method for protecting a plurality of servers from hacking attacks by using a web based protection module to identify common vulnerabilities shared by a number of the servers. The method may include: aggregating data relating to activity of a plurality of servers 502, analyzing the data relating to activity of the plurality of servers 504, identifying at least one security vulnerability common to at least a selection of the plurality of servers 506, generating at least one protective element for preventing exploitation of at least one common vulnerability 508, communicating at least one protective element to at least one of the selection of vulnerable servers 510 and executing the protective element on the vulnerable servers 512.

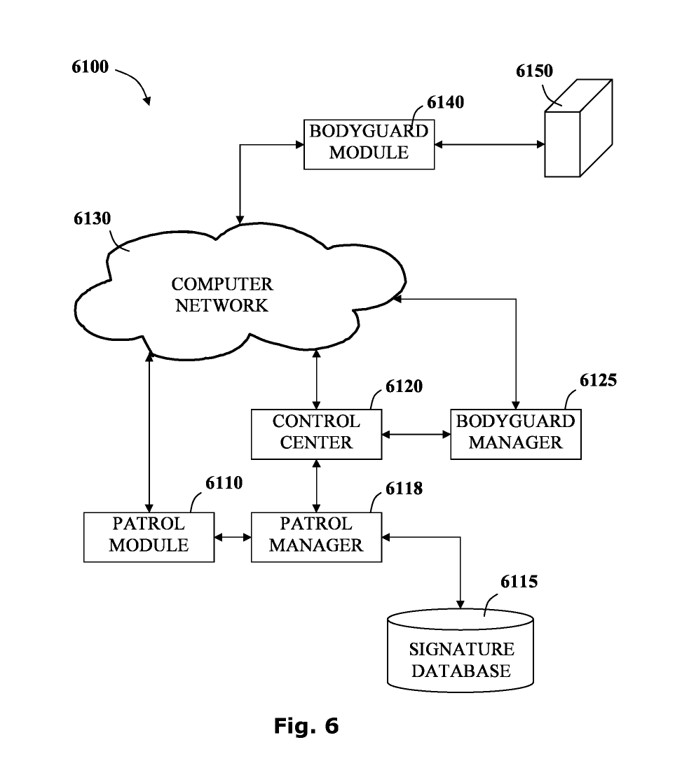

For the purposes of illustration only, a particular embodiment of an automated website intrusion protection system 6100 is presented in the block diagram of FIG. 6. The embodiment of the intrusion protection system 6100 described herein is not intended to represent an exclusive or even typical example, but rather to serve as an illustration which may at least partially clarify the disclosure. It will be appreciated that other intrusion protection systems, such as various embodiments of the system for protecting servers from hacking attacks as described herein, may be used where appropriate. Nevertheless, the intrusion protection system 6100 of the illustrative embodiment may include a bodyguard module 6140, communicatively coupled to a bodyguard manager 6125, connected to a computer network 6130. The bodyguard module 6140 may be hardware and/or software based, positioned along the connection between the computer network 6130 and the server 6150. The bodyguard module 6140 may be independent or integrated with the server 6150, as suit requirements.

The system 6100 may include a patrol module 6110, which may be a hardware and/or software element connected to computer network 6130. Patrol module 6110 may be communicatively coupled to a patrol manager 6118, which may be used to control the operation of the patrol module 6110. The patrol manager 6118 may be coupled to a signature database 6115, configured and operable to maintain, research, collect and/or develop records of known security vulnerabilities, including signatures and fix data identifying, blocking, handling, solving, neutralizing, quarantining or otherwise managing such vulnerabilities. Vulnerabilities may be discovered or located using web crawling, research, data importing, database searching, manual data entry, statistical analysis of collected data and the like. The patrol manager 6118 may be coupled to a control center 6120, possibly configured and operable to enable user interaction and control of the system 6100.

The bodyguard manager 6125, which may be coupled to the control center 6120, and to bodyguard module 6140, may provide data, such as commands or instructions, to bodyguard module 6140. Furthermore, where appropriate the bodyguard module 6140 may also send data to bodyguard manager 6125, for example, attack statistics, logs and the like. The system 6100 may be controlled by a user, such as a web manager, server owner, information technology manager or other such person responsible for web server performance and/or security. The user may control and/or manage system 6100. Where required, some embodiments of the system may be distributed computing systems such as cloud based architecture, and may be able to protect against intrusion of cloud based websites and applications, as well as providing fixes of potential vulnerabilities.

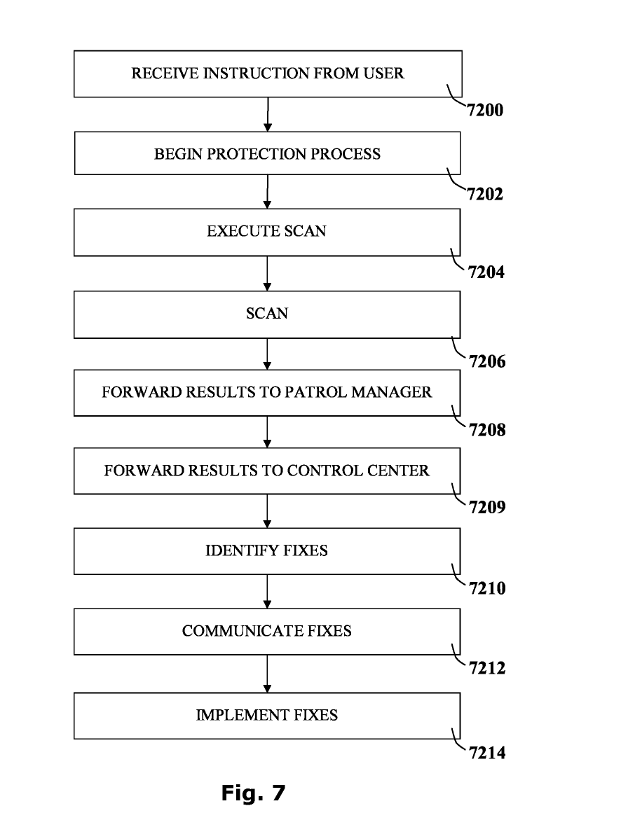

The flowchart of FIG. 7 is provided, for illustrative purposes only, to present a possible series of operations or processes that may be implemented by a system 6100, such as presented in FIG. 6, to enable automated active intrusion prevention, according to some embodiments. Although not intended to represent the only or even a typical method, the illustrative method may include, inter alia:

At stage 7200, a system user may instruct a control center 6120 to protect a server 6150. In some cases, the user may instruct the control center to perform a one time scan, yet in other cases the user may instruct the control center to perform scans periodically, at random intervals, or according to other, possibly time based, criteria.

At stage 7202 control center 6120 may instruct the patrol manager 6118 to begin an active intrusion protection process.

At stage 7204, the patrol manager 6118 instructs the patrol module 6110 to execute a server scan in order to initiate the active intrusion prevention process.

At stage 7206 the patrol module 6110 performs a web server scan to identify web server hardware and/or software characteristics and configuration, to help identify security vulnerabilities on Web server 6150. One or more web server scanner techniques may be implemented to help identify some vulnerabilities, including, for example, SQL injections, cross site scripting, malicious file uploads, directory traversals, hacking attacks, defacement attacks, virus attacks, malware attacks, ransom attacks, commercial data or fraud seeking attacks, and/or other vulnerabilities.

At stage 7208, patrol module 6110 forwards scan results and/or data to patrol manager 6118, which in turn forwards these results or data to control center 6120.

At stage 7210, the control center 6120 may interact with the signature database 6115 to determine or identify fixes for the located vulnerabilities. In some cases a generic fix may be located, identified, or otherwise applied to handle one or more identified threats, for example, to handle attacks for which no clear or known patch or fix is currently available.

At stage 7212, the control center 6120 may instruct the bodyguard manager 6125 to implement user instructions, for example, to report on security vulnerabilities, suggest security fixes, and/or automatically provide security fixes, such as patches or virtual patches, to secure the server 6150 against one or more security threats. In some cases user instructions may include requesting further user instructions at various stages of fix implementation, whereas in other cases user instructions may be to automatically or semi-automatically implement fix instructions.

At stage 7214, the bodyguard manager 6125 may command the bodyguard module 6140 to implement one or more protective elements such as selected or generated patches or fixes for the server 6150. Any combination of the above steps may be implemented. Further, other steps or series of steps may be used.

According to some embodiments, protective elements directed towards protection of known or identified attacks acquired by signature database 6115 may be preemptively sent to bodyguard module 6140, to prepare the server for expected or potential attacks before they happen. If an attacker tries to launch an attack on a web server 6150, using one or more of these previously identified or known attacks, the bodyguard module 6140 is enabled to identify the attack pattern or characteristic, and automatically implement one or more selected blocks or preventative measures to prevent the attacker from gaining unauthorized access or causing damage to the server 6150.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. A system for protecting at least one server in communication with a computer network from hacking attacks, the system comprising:
at least one scanner operable to monitor activity of said server, to identify at least one security vulnerability, and further operable to produce an automated report; and
at least one report processor operable to analyze said automated report.

2. The system of claim 1 wherein said report processor is further operable to generate at least one protective element so as to prevent exploitation of said at least one vulnerability.

3. The system of claim 1 further comprising at least one communicator operable to communicate at least one protective element to said server so as to prevent exploitation of said at least one vulnerability.

4. The system of claim 1 wherein said protective element comprises a software based element selected from a group consisting of: patches, virtual patches, black lists, filters, reconfigurations, redirects and combinations thereof.

5. The system of claim 1 further comprising a control center operable to manage at least one of said scanner and said report processor.

6. The system of claim 3 further comprising a control center operable to manage at least one of said scanner, said report processor and said communicator.

7. The system of claim 5 wherein said control center is operable to instruct said scanner to initiate monitoring activity.

8. The system of claim 7 wherein said control center is operable to configure a timed schedule for monitoring activity.

9. The system of claim 5 wherein said control center is operable to receive said automated report from said scanner and to transfer said automated report to said report processor.

10. The system of claim 5 wherein said control center is operable to receive at least one protective element from said report processor.

11. The system of claim 5 wherein said control center is operable to communicate at least one protective element to said server.

12. The system of claim 5 wherein said control center is controllable manually.

13. The system of claim 1 wherein an agent application is executed on said at least one server and said system is operable to communicate with said agent application.

14. The system of claim 13 wherein said agent application is operable to save a log of activity on said server.

15. The system of claim 13 wherein said agent application is operable to implement said protective elements on said server.

16. The system of claim 13 wherein said agent application is operable to block potential threats from exploiting said at least one security vulnerability.

17. The system of claim 13 wherein said agent application is operable to provide said scanner access to said server.

18. A system for protecting a plurality of servers in communication with a computer network from hacking attacks, the system comprising:
at least one aggregator configured to receive data relating to activity of said plurality of servers;
at least one data processor operable to analyze said data relating to activity of said plurality of servers and to identify at least one security vulnerability common to at least a selection of said plurality of servers.

19. The system of claim 18 wherein said data processor is further operable to generate at least one protective element so as to prevent exploitation of at least one common vulnerability.

20. The system of claim 18 further comprising at least one communicator operable to communicate at least one protective element to at least one of said selection of vulnerable servers.

21. A method for protecting at least one server in communication with a computer network from hacking attacks, comprising:
executing an agent application on said at least one server;
monitoring activity of said at least one server;
identifying at least one security vulnerability;
producing an automated report;
analyzing said automated report; and
providing at least one software based protective element.

22. The method of claim 21 further comprising:
aggregating data relating to activity of a plurality of servers;
analyzing said data relating to activity of the plurality of servers; and
identifying at least one security vulnerability common to at least a selection of said plurality of servers.

23. The method of claim 22 further comprising:
generating at least one protective element for preventing exploitation of at least one common vulnerability.

24. The method of claim 22 further comprising:
communicating at least one protective element to at least one of said selection of vulnerable servers.
